(19) United States
(12) Patent Application Publication
(10) Pub. No.: US 2020/0029621 A1
(43) Pub. Date: Jan. 30, 2020

(54) WRIST ACCESSORY INCLUDING A VAPING DEVICE

(71) Applicant: Chief Watches LLC, Rowlett, TX (US)

(72) Inventors: Logan Teter, Rowlett, TX (US); Colin Gaines, Rowlett, TX (US)

(21) Appl. No.: 16/423,324

(22) Filed: May 28, 2019

Related U.S. Application Data
(60) Provisional application No. 62/703,179, filed on Jul. 25, 2018.

(51) Int. Cl. A24F 47/00; A24F 3/00; A24F 7/00; A44C 5/00; G04B 47/00

(52) U.S. Cl. CPC A24F 47/008; A24F 3/00; G04B 47/00; A44C 5/0007; A24F 7/00

(57) ABSTRACT

The disclosure provides a wrist accessory. In one example, the wrist accessory includes: (1) a wrist band sized to be received around a wrist of a wearer, and (2) a vaping device coupled to the wrist band. In another example, the wrist accessory includes: (1) a wrist band sized to be received around a wrist of a wearer, (2) a watch coupled to the wrist band, and (3) a vaping device, coupled to the wrist band, having a mouthpiece, a reservoir for product, and a vaporizer.

### CROSS-REFERENCE TO PROVISIONAL APPLICATION

This application claims the benefit of U.S. Provisional Application No. 62/703,179 entitled “VAPING DEVICE AND WRIST WATCH COMBINATION” to Logan Teter, et al., filed on Jul. 25, 2018, which is commonly assigned with the present disclosure and is incorporated herein by reference in its entirety.

### TECHNICAL FIELD

The disclosure relates to, in general, vaping devices and, more specifically, to a vaping device that can be secured to a user.

### BACKGROUND

A vaping device, or vaporizer, is a device used to vaporize substances for inhalation. The substances can be, for example, plant substances or fluid substances. The plant substances can be cannabis, tobacco, or other herbs, and the fluid substances can be a mix of propylene glycol or glycerin with drugs, such as nicotine or tetrahydrocannabinol. Vaping devices may vary widely in design, with some examples having extraction chambers, ignition chambers, or heating chambers. Some vaping devices can include electronic vaporizers that energize a heating coil to vaporize fluids. Typically these vaping devices use a battery to energize the heating coil. When vaporized, the fluids, which may be known as e-liquids, can create a vapor that may be inhaled directly by a user.

### SUMMARY

The disclosure provides a wrist accessory. In one embodiment, the wrist accessory includes: (1) a wrist band sized to be received around a wrist of a wearer, and (2) a vaping device coupled to the wrist band.

In another embodiment, the wrist accessory includes: (1) a wrist band sized to be received around a wrist of a wearer, (2) a watch coupled to the wrist band, and (3) a vaping device, coupled to the wrist band, having a mouthpiece, a reservoir for product, and a vaporizer.

The foregoing has outlined features so that those skilled in the art may better understand the detailed description that follows. Additional features will be described. Those skilled in the art should appreciate that they can readily use the disclosed conception and specific examples as a basis for designing or modifying other structures for carrying out the same purposes disclosed herein. Those skilled in the art should also realize that such equivalent constructions do not depart from the spirit and scope of the disclosure.

### DETAILED DESCRIPTION

The usage of vaping devices may not be appropriate or accepted in certain situations. This can be a challenge to users that carry their vaping device since the vaping device is easily visible. In addition to the conspicuousness, carrying around a vaping device inconveniently requires users to keep track of their hand-held vaping devices to maintain security of the device. This can be a problem when users continually set down their vaping devices in order to free their hands for the activities of a day. Continually setting the vaping device down can lead to unauthorized use of the device, or worse, can lead to the device being misplaced or stolen.

Accordingly, the disclosure provides a wearable vaping device that provides an indiscrete vaping option for users. The wearable vaping device is part of a wrist accessory that can be secured around the wrist of a user allowing the user to easily control access to the device. Additionally, since the vaping device is wearable, users do not have to carry or keep track of the vaping device once the device is secured around their wrist. With the vaping device secured on a wrist, users also do not have to hold the wearable vaping device or use their hands to bring the vaping device to their mouths for use. The wearable vaping device can be secured to a wrist similarly to how a watch or wrist band is worn, and can resemble the look of a wrist watch or wrist band when worn. In some examples, the vaping device can be combined with a watch to provide a single wearable device.

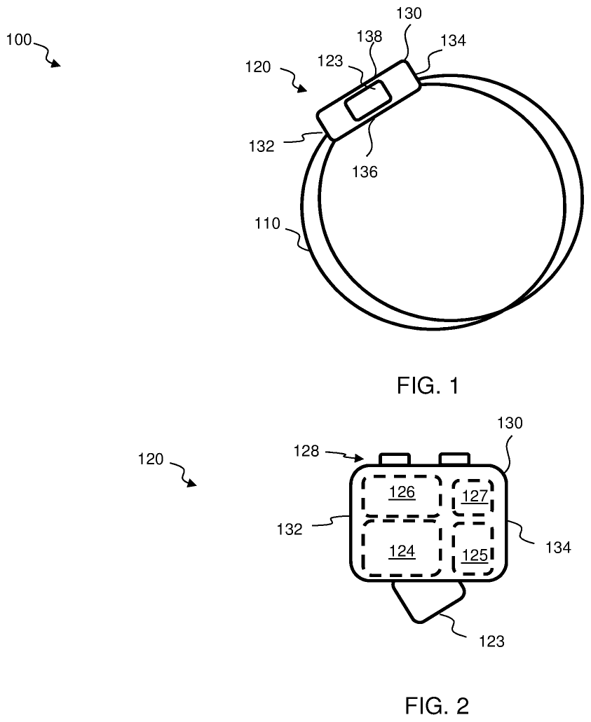

Turning now to the figures, FIG. 1 illustrates a diagram of an example of a wrist accessory 100 constructed according to the principles of the disclosure. The wrist accessory 100 is a functional accessory to be worn around the wrist of a user. In some examples, the wrist accessory 100 can also be a fashion accessory for the wrist. The wrist accessory 100 includes a wrist band 110 and a vaping device 120 that is attached to the wrist band 110. The vaping device 120 includes a mouthpiece 123 and a housing 130.

The wrist band 110 is sized to be received around the wrist of a wearer. The wrist band 110 can be constructed of various materials including rubber, plastic, leather, and fabric. In the illustrated example of FIG. 1, the wrist band 110 is in a single piece, or in one section, that connects to opposite ends or sides of the vaping device 120, denoted as attachment sides 132 and 134 of the housing 130. As such, the wrist band 110 can be a single flexible strap that is permanently connected to both of the attachment sides 132, 134, such that the wrist accessory 100 is slid over a wrist of a user when the wrist accessory 100 is worn. The wrist band 110 can be connected to the attachment sides 132, 134, via conventional means. In some examples, the wrist band 110 is removeably connected to at least one of the attachment sides 132, 134, such that the wrist accessory 100 is secured around a wrist by wrapping the wrist band 110 around the wrist and connecting the wrist band 110 to one of the attachment sides 132, 134. The wrist band 110 can also be removeably coupled to both attachment sides 132, 134, to allow the wrist band 110 to be easily replaced.

As disclosed in other examples, a wrist band can also have multiple sections that may be fastened around the wrist of a user. The multiple sections can be adjustable via conventional means, such as, a sliding buckle design, a pin buckle, or a multiple hole design. The multiple sections can be a male band section and a female band section. The male band section can be attached to the attachment side 132 and the female band section may be attached to the attachment side 134. In this way, the housing 130 may be placed over the wrist of a user with the male band section and female band section extending in opposite directions around the wrist of the user to mate on the back of the wrist of the user. The male band section and female band section may be attached to each other by any appropriate means for joining a wrist band such that the wrist band 110 attaches itself to the wrist of the user.

The vaping device 120 can operate as one of multiple types of vaping devices known in the art. In one example, the vaping device 120 is an electronic vaping device designed for use with e-liquids. In addition to the mouthpiece 123 and the housing 130, the vaping device 120 can also include additional components that are not shown in FIG. 1. Some of the additional components, such as a reservoir and a vaporizer, can be within the housing 130.

The housing 130 may comprise a geometric shape such as, for example, a square, circle, or rectangle, having a depth and a hollow inner opening that houses the internal components of the vaping device 120. The housing 130 has a wrist side 136 and a top side 138 in addition to the attachment sides 132, 134, that form the shape of the housing 130 and define the volume of the housing 130 that includes the internal components. With some vaping devices, such as when the housing 130 is in the shape of a circle, instead of having attachment sides, the wrist band 110 can be attached to the housing 130 at attachment points on a side that extends between the wrist side 136 and the top side 138.

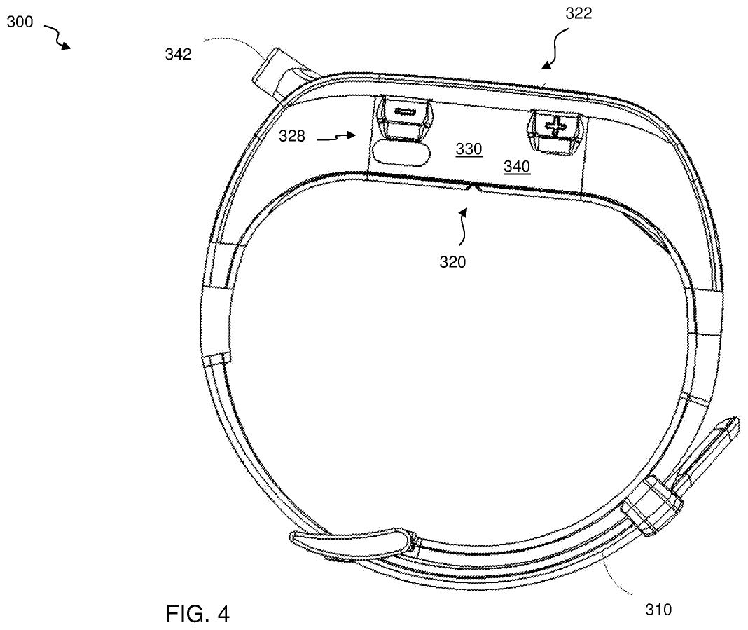

The wrist side 136 is designed to be placed against the wrist of a user. As such, the wrist side 136 can be substantially flat similar to the bottom side of a wrist watch. The top side 138 can also be substantially flat and can include a display. The display can be constructed similar to display 335 discussed below. As illustrated, the wrist side 136 and the top side 138 can be parallel to each other and the attachment sides 132, 134, can be parallel to each other. Some components, such as buttons, may extend through the various walls or sides of the housing 130, as desired, for additional functionality and user interactivity. FIG. 2 illustrates examples of such protrusions, buttons 128. FIG. 4 also illustrates examples of buttons and interfaces that can be used with the vaping device 120.

FIG. 2 illustrates a top view of the vaping device 120 that shows additional components of the vaping device 120, including components within the housing 130 of the vaping device 120. The internal components include a reservoir 124, a vaporizer 125, a processor 126, and a power source 127. The internal components can be connected together as typically connected within a vaping device to perform the functions of a vaping device. The attachment sides 132, 134, and the mouthpiece 123 as denoted in FIG. 1 are also shown in FIG. 2. Additionally, buttons 128 of the vaping device 120 that were not visible in the view of FIG. 1 are illustrated. The wrist side 136 or top side 138, or a portion thereof, can be removable to allow access to the internal components and replacing thereof.

The mouthpiece 123 may be fixedly attached to the housing 130. In some examples, the mouthpiece 123 can be removeably attached to the housing 130 to allow for user customization of the device. In FIG. 2, the mouthpiece 123 is angled with respect to the housing 130 to provide easier access for a user. As shown in other examples disclosed herein, a mouthpiece can be alternatively positioned on one of the attachment sides 132, 134. In such examples, the mouthpiece can be aligned with the wrist band, i.e., positioned in-line with the wrist band.

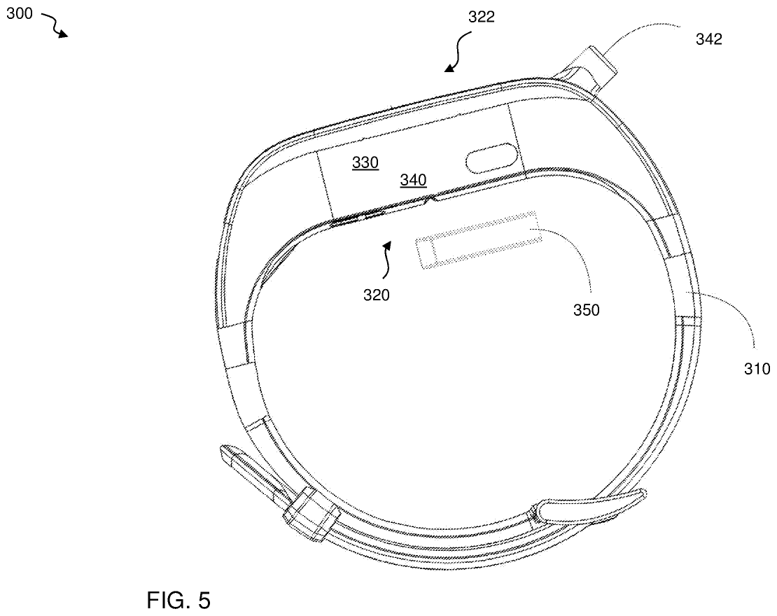

The reservoir 124 stores product for use by the vaping device 120. The product can be an e-liquid. In one example, the reservoir 124 is a removeable cartridge that is received by a cartridge-receiving compartment within the housing 130. FIG. 5 illustrates an example of such a cartridge, replaceable cartridge 350. The cartridge may be a proprietary-shaped cartridge or may be any cartridge commonly known in the art, and may comprise a plurality of varying types or flavors of e-liquids to suit user preferences. The cartridge itself may comprise an onboard sensor or processors to determine its fill level. The fill level can be reported to the processor 126 and used to inform a user. A display at the top side 138 can be used to visually inform the user. An audible indication could also be used. The cartridge may be removed and replaced from the housing 130 as desired, to allow a user to refill or replace the product, such as an e-liquid, being used within the vaping device 120.

The vaporizer 125 is constructed to vaporize product within the reservoir 124 into an inhalable vapor that can then be inhaled by a user through the mouthpiece 123. In one example, the vaporizer 125 includes a fuel tank and an ignition coil for vaporizing the product. In another example, the vaporizer 125 includes a fuel tank and a heating element such as, for example, a heating coil and wick combination, for vaporizing the product into an inhalable vapor. The vaporizer 125 can also include a ceramic coil system. The fuel tank may comprise a removable or replaceable cartridge, such as the replaceable cartridge 350 in FIG. 5. In some examples, the fuel tank includes an opening or other means for receiving fuel, and the ignition coil or heating coil is removeably attached such that the ignition or heating coil may be maintained or replaced as needed.

The processor 126 is configured to control various functions of the vaping device 120. The processor 126, for example, can control operation of the vaporizer 125. The processor 126 can be located on a main processor board and communicatively coupled with other components within the housing 130. The processor 126 can be implemented as a programmable device such as a field-programmable gate array (FPGA), or as dedicated circuitry. The processor 126 can be implemented as microcontroller. In various examples, the processor 126 is a central processing unit (CPU). In some examples disclosed herein, the processor 126 can control various functions of a watch in addition to the functions of the vaping device 120.

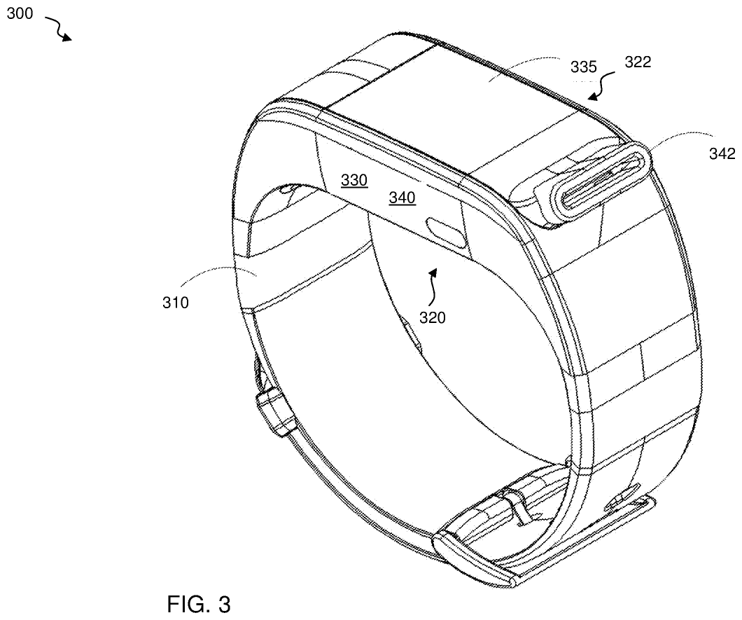

The power source 127 can be a conventional device that provides power for operation of the vaping device 120. For example, the power source 127 can provide power for the vaporizer 125 and the reservoir 124. The power source 127 can include a battery, such as a lithium-polymer battery, or other similar component. The battery can be rechargeable or replaceable. The battery can be designed to automatically recharge by movement of a user, such as by walking or by moving their wrist. The battery can also be solar powered. The power source 127 can include a backup power supply, which may include a power capacitor or other similar component. As noted above, the vaping device 120 can be combined with a watch in a single device. In such devices, the power source 127 can provide power for both the vaping device 120 and the watch. Alternatively, the vaping device 120 can have a dedicated power source and the watch can have a different dedicated power source. In some examples with dedicated power sources, a single backup power supply can be used for both. FIGS. 3 to 5 illustrate an example of a vaping device and a wrist watch combined into a single device.

The buttons 128 are operable to be engaged by the user to cycle through and interact with the various options and parameters for controlling the various functional parameters of the vaping device 120. The buttons 128 can be used to interact with the processor 126 and/or software integrated within the main processor board to control at least some of the functions of the vaping device 120. The buttons 128, or at least one of the buttons 128, can be used to activate the vaporizer 125 to convert the product within the reservoir 124 into vapor for inhalation. One of the buttons 128 can also be used to check the fuel level. In some examples, the vaping device 120 can include a single button that is used to toggle through various functions to be initiated. In other examples, the vaping device 120 can include more than two buttons for controlling functions. The vaping device 120 may also include no buttons for controlling various functions. For example, the vaporizer 125 can be automatically activated when a user inhales through the mouthpiece 123 such that manual activation through one of the buttons 128 is not needed. With automatic activation, the vaping device 120 can operate without a processor to provide a lower cost option. In such example, limited circuitry can be used to activate the vaporizer 125 when an inhale is detected.

FIG. 3 illustrates a diagram of an example of a wrist accessory 300 constructed according to the principles of the disclosure. The wrist accessory 300 combines the functionality of a watch and a vaping device into a single wearable device. The wrist accessory 300 includes a wrist band 310 and a central housing (i.e., housing) 320 that includes a wrist watch 330 and a vaping device 340.

The wrist band 310 is a strap with two removably attached ends that may be fastened around the wrist of a user. In other examples a wrist band can be any type of band known in the art, such as a one-piece similar to the wrist band 110 of FIG. 1. Like the wrist band 110, the wrist band 310 can be constructed of various types of materials, including rubber, plastic, leather, or fabric, and may be adjustable via a plurality of means commonly used in the art. Such means may include, for example, a sliding buckle design or a pin buckle and plurality of holes design, as preferred.

The housing 320 includes a cover 322 that serves to create an upper surface of the central housing and protect the plurality of internal components of the wrist watch 330 and the vaping device 340. The cover 322 can include multiple sections wherein a first section allows a display 335 associated with the wrist watch 330 and/or the vaping device 340 to be visualized. A mouthpiece 342 of the vaping device 340 may be integrated into a second section of the cover 322. The cover 322 may be removably attached to the housing 320 such that it may be swapped out, as desired, by a user for aesthetic or functional purposes. Various covers, for example, may be made available in different colors or with differently-shaped mouthpieces.

The wrist watch 330 can be any type of watch known in the art, whether mechanical, electronic, analog, digital, or any combination thereof. In one example the wrist watch 330 is a digital watch comprising a control board, a plurality of watch components, and the display 335. The display 335 may be an electronic display, such as a light-emitting diode (LED) display, an organic LED (OLED) or a liquid-crystal display (LCD). The time may be displayed as a clock face with hour, minute, and second hands, or as a series of digits to represent hours, minutes, and seconds. The wrist watch 330 may further incorporate any means for maintaining accurate time known in the art, and may specifically incorporate wireless connectivity for automatically correcting time based on Internet servers or other reliable sources. The control board and the plurality of watch components can be located internally within the housing 320. The interface for connecting can extend through a side of the housing 320, such as one of the protrusions 328 in FIG. 4.

The vaping device 340 can operate as one of multiple types of vaping devices known in the art. The vaping device 340 can be similarly configured as the vaping device 120 of FIG. 1. For example, the vaping device 340 can have internal components that are included within the housing 320. The vaping device 340 can be located within the housing 320 except for a portion of the mouthpiece 342. As such, the vaping device 340 can be substantially located within the housing 320. The watch 330 can also be located within the housing.

The plurality of internal components within the housing 320 can include a main processor board to which the other internal components are attached. The main processor board can include a processor configured to control the various functions of the wrist watch 330 and the vaping device 340. The processor can be, or implemented similarly to, the processor 126 of FIG. 2. The processor board may be attached to the display 335 for display purposes and to the vaporizer of the vaping device 340 for activation and control. The main processor board may be further connected to a power supply, which may comprise a lithium-polymer battery or other similar component, and a backup power supply, which may comprise a power capacitor or other similar component. The power supply can provide power for the watch 330 and the vaping device 340. In some example, the watch 330 and the vaping device 340 can have their own distinct processor and power supply.

As illustrated in FIG. 4, the housing 320 may further comprise a plurality of surface protrusions 328 that are themselves connected to the plurality of internal components within the housing 320 to facilitate user control of the wrist accessory 300. By way of example, the plurality of surface protrusions 328 may comprise a universal serial bus (USB) connection, to which a user may connect a USB cable for recharging the power supply of the wrist accessory 300 or interfacing the wrist accessory 300 with a software application. The USB cable may allow the user, through the use of a software application, to program various functional parameters of the vaping device 340 or to program the various functional parameters of the watch 330. The plurality of surface protrusions 328 may further comprise a plurality of buttons that may be engaged by the user to cycle through and interact with the various options and parameters of the software integrated within the main processor board for controlling the various functional parameters of the watch 330 and/or the vaping device 340.

The wrist accessory 300 can include functionality in addition to that described above. In one example the wrist watch 330 may employ the display 335 to display the date and day of the week. In another example the wrist watch 330 can provide a background image to the display 335 and can allow customizing the background image for display. In one example the wrist accessory 300 may incorporate wireless connectivity, such as internet, cellular, or Bluetooth technologies to provide a user with advanced modern functionalities. The main processor board can include a wireless transceiver for the wireless connectivity. The wrist accessory 300 may further integrate smart phone or smart watch concepts to provide a user with access to mobile software applications, or may comprise a proprietary software application that allows a user to control or observe the status of the vaping device 340. Connectors or interfaces of the plurality of protrusions 328 can be used to implement the additional functionality.

FIG. 5 illustrates the wrist accessory 300 including a replaceable cartridge 350. The replaceable cartridge 350 can be used as the reservoir to store product for the vaping device 340 or a fuel tank for the vaporizer of the vaping device 340. The replaceable cartridge 350 can be mechanically attached to or coupled within the housing 320. In some examples, the replaceable cartridge 350 can fit within a compartment of the housing 320.

The wrist accessories disclosed herein, such as wrist accessory 100 or 300, or components thereof, can be constructed of a combination of materials. Typically the wrist accessories are constructed of a resilient material or combination of materials such that the wrist accessories are resistant to tearing and damage as a result of compression, twisting, heating, or submersion in water. As an example, and without limiting the scope of the disclosure, various examples of the wrist accessories may be substantially constructed of one or more materials of plastic, acrylic, polycarbonate, steel, aluminum, brass, fiberglass, carbon fiber, or combinations thereof. In some examples the various components of the wrist accessories may be coated, lined, or otherwise insulated to prevent leakage of fluid out of the device, such as from a reservoir or fuel tank. In one example the material of construction may vary from one component to the next within the wrist accessory. By way of example, the cover 322 of the housing 320 may include a transparent or translucent material of construction such that the contents within may be easily visualized.

The wrist accessories can be constructed of a material having antimicrobial properties or can have a layer of antimicrobial material or coating. Antimicrobial properties comprise the characteristic of being antibacterial, biocidal, microbicidal, anti-fungal, anti-viral, or other similar characteristics, and the oligodynamic effect, which is possessed by copper, brass, silver, gold, and several other metals and alloys, is one such characteristic.

A portion of the above-described apparatus, systems or methods may be embodied in or performed by various digital data processors that are programmed or store executable programs of sequences of software instructions to perform one or more of the steps of the methods, such as operating a watch or vaping device. The software instructions of such programs may represent algorithms and be encoded in machine-executable form on non-transitory digital data storage media, e.g., magnetic or optical disks, random-access memory (RAM), magnetic hard disks, flash memories, and/or read-only memory (ROM), to enable various types of digital data processors to perform one, multiple or all of the steps of one or more of the above-described methods, or functions, systems or apparatuses described herein.

Portions of disclosed embodiments may relate to computer storage products with a non-transitory computer-readable medium that have program code thereon for performing various computer-implemented operations that embody a part of an apparatus, device or carry out the steps of a method set forth herein. Non-transitory used herein refers to all computer-readable media except for transitory, propagating signals. Examples of non-transitory computer-readable media include, but are not limited to, hardware devices that are specially configured to store and execute program code, such as ROM and RAM devices.

Those skilled in the art to which this application relates will appreciate that other and further additions, deletions, substitutions and modifications may be made to the described embodiments.

What is claimed is:

1. A wrist accessory, comprising:
a wrist band sized to be received around a wrist of a wearer; and
a vaping device coupled to the wrist band.

2. The wrist accessory as recited in claim 1, further comprising a watch coupled to the wrist band.

3. The wrist accessory as recited in claim 1 wherein the wrist band includes a first section and a second section that are coupled together to secure the wrist band around the wrist of the wearer, wherein the vaping device is coupled between the first section and the second section.

4. The wrist accessory as recited in claim 3 further comprising a watch, wherein both the vaping device and the watch are coupled between the first section and the second section.

5. The wrist accessory as recited in claim 1 wherein the vaping device includes a mouthpiece, a vaporizer, and a reservoir for product.

6. The wrist accessory as recited in claim 5 wherein the mouthpiece is in-line with the wrist band.

7. The wrist accessory as recited in claim 5 wherein the vaporizer includes a fuel tank and a heating element.

8. The wrist accessory as recited in claim 5 wherein the vaping device includes a housing having a wrist side and a top side, and the vaporizer and the reservoir are located within the housing.

9. The wrist accessory as recited in claim 1 further comprising a processor configured to control operation of the vaping device and a power source to provide power to the processor and the vaping device.

10. The wrist accessory as recited in claim 9 further comprising at least one button that is configured to operate with the processor to control an operation of the vaping device.

11. The wrist accessory as recited in claim 10 wherein the operation is activating a vaporizer of the vaping device.

12. The wrist accessory as recited in claim 9 further comprising a watch and at least one button that is configured to operate with the processor to control an operation of the vaping device and control an operation of the watch.

13. The wrist accessory as recited in claim 12 wherein the power source further provides power to the watch.

14. A wrist accessory, comprising:
a wrist band sized to be received around a wrist of a wearer;
a watch coupled to the wrist band; and
a vaping device, coupled to the wrist band, having a mouthpiece, a reservoir for product, and a vaporizer.

15. The wrist accessory as recited in claim 14 wherein the wrist band includes a first section and a second section and the vaping device and the watch are coupled between the first section and the second section.

16. The wrist accessory as recited in claim 15 further comprising a processor configured to control operations of the vaping device and the watch.

17. The wrist accessory as recited in claim 16 wherein one of the operations is activating the vaporizer.

18. The wrist accessory as recited in claim 16 further comprising a power source, wherein the vaping device and the processor receive power from the power source.

19. The wrist accessory as recited in claim 14 further comprising a housing coupled to the wrist band, wherein the watch and the vaping device are substantially located within the housing.

20. The wrist accessory as recited in claim 19 wherein the mouthpiece is positioned in-line with the wrist band.
